(19) United States
(12) Patent Application Publication
(10) Pub. No.: US 2022/0407771 A1
(43) Pub. Date: Dec. 22, 2022

(54) METHOD AND APPARATUS FOR UPDATING INSTANCE CONFIGURATION, DEVICE, STORAGE MEDIUM, AND PROGRAM PRODUCT

(71) Applicant: BEIJING BAIDU NETCOM SCIENCE TECHNOLOGY CO., LTD., Beijing (CN)

(72) Inventor: Chenfei WANG, Beijing (CN)

(21) Appl. No.: 17/890,929

(22) Filed: Aug. 18, 2022

(30) Foreign Application Priority Data
Nov. 25, 2021 (CN) 202111415040.9

(51) Int. Cl. H04L 41/082; H04L 41/084

(52) U.S. Cl. CPC H04L 41/082; H04L 41/0846

(57) ABSTRACT

A method and apparatus for updating an instance configuration, and a computer program product are provided. The method includes: determining, for a plurality of servers included in a node, a representative server based on consistent hash; determining, for a plurality of instances running on the servers, a representative-of-server instance based on the consistent hash, and determining the representative-of-server instance of the representative server as a representative-of-node instance; delivering a first control parameter to a common server instance, where the first control parameter is used for instructing to initiate a configuration updating request only to a representative-of-server instance of a same server; and delivering a second control parameter to the representative-of-server instance, where the second control parameter is used for instructing to initiate a configuration updating request only to the representative-of-node instance.

### TECHNICAL FIELD

The present disclosure relates to the technical field of data processing, in particular to the technical field of media cloud such as content distribution network and cluster configuration, and in particular to a method, apparatus, electronic device, computer-readable storage medium and computer program product for updating instance configuration.

### BACKGROUND TECHNIQUE

CDN (Content Delivery Network, Content Delivery Network) relies on edge servers deployed in various places, through the load balancing, content distribution, scheduling and other functional modules of the control center, so that users can obtain the required content nearby, reduce network congestion, and improve user access response speed and hit rate. Each node that constitutes a CDN usually includes multiple servers, and in order to improve the performance utilization of servers, multiple service instances are usually created based on server resources through virtualization technology.

For each instance, considering the need for service flexibility, many service parameters in the instance are not hard-coded, but are determined through dynamic configuration and delivery. In order to ensure the latest configuration, each instance will occasionally go to the control center (also called the control center, console) to pull the latest configuration, that is, the object that each instance initiates a configuration request is the control center.

### SUMMARY OF THE INVENTION

Embodiments of the present disclosure propose an instance configuration update method, apparatus, electronic device, computer-readable storage medium, and computer program product.

In a first aspect, an embodiment of the present disclosure proposes a method for updating an instance configuration, including: for multiple servers included in a node, determining a representative server based on a consistent hash; for multiple instances running on the server, determining a representative server based on a consistent hash Determine the server representative instance, and determine the server representative instance representing the server as the node representative instance; issue the first control parameter to the server common instance that is not the server representative instance; wherein, the first control parameter is used to instruct the server common instance only to the same server representative instance. The server representative instance of the server initiates a configuration update request; sends a second control parameter to the server representative instance; wherein the second control parameter is used to instruct the server representative instance to only initiate a configuration update request to the node representative instance.

In a second aspect, an embodiment of the present disclosure provides an instance configuration updating apparatus, including: a representative server determination unit, configured to determine a representative server based on a consistent hash for a plurality of servers included in a node; a representative instance determination unit, configured by It is configured to, for multiple instances running on the server, determine the server representative instance based on the consistent hash, and determine the server representative instance representing the server as the node representative instance; the first control parameter issuing unit is configured to send the non-server representative instance to the server representative instance. The server common instance of the instance issues the first control parameter; wherein, the first control parameter is used to instruct the server common instance to only initiate a configuration update request to the server representative instance of the same server; the second control parameter issuing unit is configured to send a request to the server The representative instance issues a second control parameter; wherein the second control parameter is used to instruct the server representative instance to only initiate a configuration update request to the node representative instance.

In a third aspect, embodiments of the present disclosure provide an electronic device, the electronic device comprising: at least one processor; and a memory communicatively connected to the at least one processor; wherein the memory stores instructions executable by the at least one processor, the instruction is executed by at least one processor, so that the at least one processor can implement the instance configuration update method described in any implementation manner of the first aspect when executed by the at least one processor.

In a fourth aspect, an embodiment of the present disclosure provides a non-transitory computer-readable storage medium storing computer instructions, where the computer instructions are used to enable a computer to implement the instance configuration update described in any implementation manner of the first aspect when executed. method.

In a fifth aspect, an embodiment of the present disclosure provides a computer program product including a computer program, which, when executed by a processor, can implement the instance configuration update method described in any of the implementation manners of the first aspect.

In the embodiment of the present disclosure, a representative server can be selected from multiple servers included in each CDN node, a server representative instance and a node representative instance can be selected from multiple instances carried by the same server, and By delivering different control parameters to different instances, the objects that different instances initiate configuration requests are adjusted, that is, the common instance in the server only initiates configuration update requests to the server representative instance, and the server representative instance only initiates configuration updates to the node representative instance. Therefore, only the remaining node representative instance will initiate a configuration update request to the console, that is, by initiating the transfer of objects, the number of requests processed by the console is greatly reduced, and a smaller number of requests processed will also shorten the processing waiting time. Shorten the time required for the new configuration to take effect.

It should be understood that what is described in this section is not intended to identify key or critical features of embodiments of the disclosure, nor is it intended to limit the scope of the disclosure. Other features of the present disclosure will become readily understood from the following description.

### DESCRIPTION OF DRAWINGS

Other features, objects and advantages of the present disclosure will become more apparent upon reading the detailed description of non-limiting embodiments taken with reference to the following drawings:

FIG. 1 is an exemplary system architecture in which the present disclosure may be applied;

FIG. 2 is a flowchart of a method for updating an instance configuration provided by an embodiment of the present disclosure;

FIG. 3 is a flowchart of another instance configuration update method provided by an embodiment of the present disclosure;

FIG. 4 is a structural block diagram of an example configuration updating apparatus provided by an embodiment of the present disclosure;

FIG. 5 is a schematic structural diagram of an electronic device suitable for executing a method for updating an instance configuration according to an embodiment of the present disclosure.

### DETAILED WAYS

Exemplary embodiments of the present disclosure are described below with reference to the accompanying drawings, which include various details of the embodiments of the present disclosure to facilitate understanding and should be considered as exemplary only. Accordingly, those of ordinary skill in the art will recognize that various changes and modifications of the embodiments described herein can be made without departing from the scope and spirit of the present disclosure. Also, descriptions of well-known functions and constructions are omitted from the following description for clarity and conciseness. It should be noted that the embodiments of the present disclosure and the features of the embodiments may be combined with each other under the condition of no conflict.

In the technical solution of the present disclosure, the collection, storage, use, processing, transmission, provision and disclosure of the user's personal information involved are all in compliance with the relevant laws and regulations, and do not violate public order and good customs.

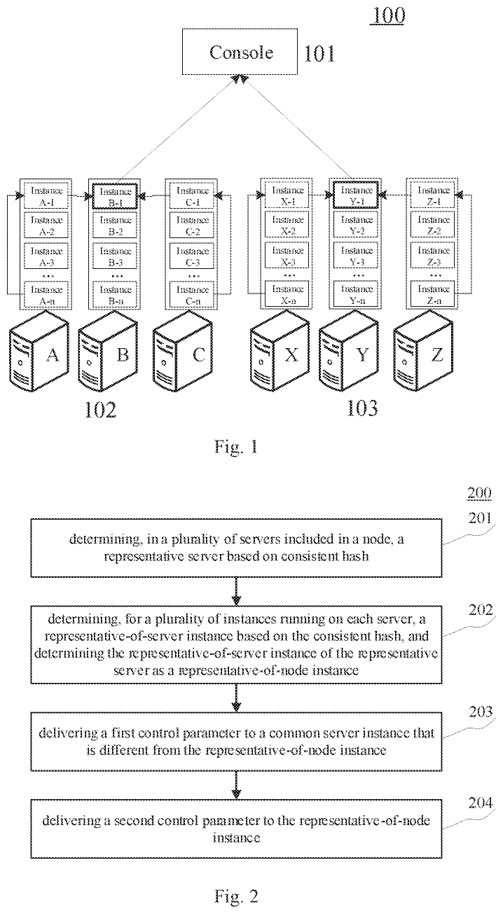

FIG. 1 illustrates an exemplary system architecture 100 to which embodiments of an example configuration update method, apparatus, electronic device, and computer-readable storage medium of the present disclosure may be applied.

As shown in FIG. 1, the system architecture 100 may be a CDN including a plurality of nodes, exemplarily including a console 101, a first node 102 and a second node 103 (more nodes are not shown one by one). The first node 102 and the second node 102 both include three servers, that is, the first node includes servers A, B, and C, and the second node 103 includes servers X, Y, and Z. These six servers also carry n Each instance is named according to the rule of “server name-number from 1 to n”.

Various applications can be installed on each node and each server to implement various functions, such as determining the server representative instance among the instances in the server, and determining the representative representing the server among the servers in the node. Select applications, such as data transmission applications and instant messaging applications for data communication between instances.

The console 101, the first node 102, the second node 103, and multiple servers included in the nodes may be hardware or software. When it is hardware, it can be implemented as a distributed server cluster composed of multiple servers, or it can be implemented as a single server; when it is software, it can be implemented as multiple software or software modules, or as a single software or software. module, which is not specifically limited here.

In order to clarify the object that each instance initiates the configuration update, each server can run the representative selection application to achieve the following technical effects: first, for the multiple servers included in the node, the representative server is determined based on the consistent hash (for example, in FIG. 1). server B in the first node 102, server Y in the second node 103); then, for multiple instances running on the server, determine the server representative instance (for example, the first node 102 in FIG. 1) based on the consistent hash instance A-1, instance C-1 in the second node 103, instance X-1, Z-1 in the second node 103), and the server representative instance representing the server is determined as the node representative instance (for example, the first node in FIG. 1). Instance B-1 in 102, instance Y-1 in the second node 103); Next, the first control parameter is issued to the server common instance that is not the server representative instance, and the second control parameter is issued to the server representative instance,

Further, after issuing the first control parameter to the common server instance, the common server instance will only initiate a configuration update request to the server representative instance of the same server according to the effective first control parameter; after issuing the first control parameter to the server representative instance; After the second control parameter, the server representative instance will only initiate a configuration update request to the node representative instance according to the effective second control parameter. The node representative instance will still initiate a configuration update request to the console according to the default control parameters. In this way, the adjustment of the initiating object of the configuration update request is realized, instead of the console.

It should be understood that the numbers of consoles, nodes, servers, and instances in FIG. 1 are merely illustrative. There can be any number of consoles, nodes, servers, instances depending on the implementation needs.

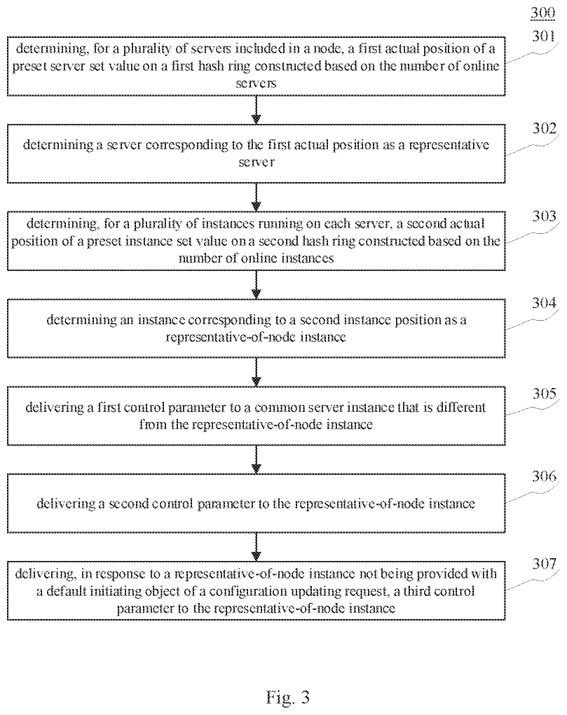

Please refer to FIG. 2, which is a flowchart of a method for updating an instance configuration according to an embodiment of the present disclosure, wherein the process 200 includes the following steps:

Step 201: for a plurality of servers included in the node, determine a representative server based on the consistent hash;

This step is aimed at determining a representative server for representing the node among the multiple servers in the node based on the consistent hash by the execution body of the instance configuration update method (eg, each server in each node shown in FIG. 1).

The consistent hash algorithm maps the entire hash value space into a virtual ring, and the value range of the entire hash value space is 0 to 2³²−1. The entire space is organized clockwise. 0˜2³²−1 The direction coincides in the zero point. Next, use the following algorithm to map the service request, use the hash algorithm to calculate the corresponding hash value of the service request, and then search clockwise along the circle according to the position of the hash value. The first server encountered is the corresponding processing request server. When a new server is added, the affected data is only the data between the newly added server and the previous server in its ring space (that is, the first server encountered in the counterclockwise direction). will not be affected. To sum up, the consistent hash algorithm only needs to relocate a small part of the data in the ring space for the increase or decrease of nodes, and has good fault tolerance and scalability.

Step 202: for multiple instances running on the server, determine the server representative instance based on the consistent hash, and determine the server representative instance representing the server as the node representative instance;

On the basis of step 201, this step is aimed at determining the server representative instance representing the server among the multiple instances in the server based on the consistent hash, and determining the server representative instance representing the server as Nodes represent instances. That is, the server representative instance in the representative server is relative to other instances in the representative server, and the node representative instance is equivalent to the server representative instance of other servers in the node.

Different from the method of determining the representative server through consistent hashing, to determine the representative instance of the server, you only need to change the number of servers that build the hash ring to the number of instances. When calculating the hash value according to the service request, it also needs to be changed to be related to the instance. request or other parameters.

Step 203: Distributing the first control parameter to the normal server instance that is not the server representative instance;

On the basis of step 202, the purpose of this step is to issue the first control parameter to the common server instance that is not the representative instance of the server by the above-mentioned execution body, so that the common server instance only sends the same server to the same server under the guidance of the effective first control parameter. The server initiates configuration update requests on behalf of the instance. That is, it can be understood that the first control parameter is used to instruct to adjust the initiating object of the configuration update request of the common instance of the server to be the server representative instance of the same server, instead of the console.

Step 204: Deliver the second control parameter to the server representative instance.

On the basis of step 202, this step aims to issue the second control parameter to the server representative instance by the above-mentioned execution body, so that the server representative instance only initiates a configuration update request to the node representative instance under the guidance of the effective second control parameter. That is, it can be understood as: the second control parameter is used to instruct to adjust the initiating object of the configuration update request of the server representative instance to be the node representative instance in the representative server, instead of the console.

The instance configuration update method provided by the embodiment of the present disclosure can select a representative server from multiple servers included in each CDN node, and select a server representative from multiple instances carried by the same server by means of consistent hashing. Instances and nodes represent instances, and by sending different control parameters to different instances, the objects that different instances initiate configuration requests are adjusted, that is, the common instance in the server only initiates configuration update requests to the server representative instance, and the server representative instance only initiates configuration update requests. Initiate a configuration update request to the node representative instance, so only the remaining node representative instance will initiate a configuration update request to the console, that is, by initiating object transfer, the number of requests processed by the console is greatly reduced, and fewer requests are processed. It will also shorten the processing and waiting time, and shorten the effective time of the new configuration.

Please refer to FIG. 3, which is a flowchart of another instance configuration update method provided by an embodiment of the present disclosure, wherein the process 300 includes the following steps:

Step 301: For a plurality of servers included in the node, determine the first actual position of the preset server setting value on the first hash ring constructed based on the number of online servers;

Step 302: Determine the server corresponding to the first actual location as the representative server;

For the upper-level solution provided in step 201, this embodiment provides a specific lower-level implementation solution through steps 301 to 302, that is, a preset server setting value is used to create a first hash ring based on the number of online servers. the first actual location. In this way, when the number of online servers remains unchanged, the first actual position will be kept the same according to the same server setting value, so that the representative server determined each time is the same, and the retention of the representative server will be avoided as much as possible. The consistency and consistency of information obtained by other non-representative servers from the representative server is beneficial to keep the configuration up-to-date.

Step 303: For multiple instances running on the server, determine the second actual position of the preset instance setting value on the second hash ring constructed based on the number of online instances;

Step 304: Determine the instance corresponding to the second instance location as the server representative instance;

For the upper-level solution provided in step 202, this embodiment provides a specific lower-level implementation solution through steps 303 to 304, that is, a preset instance setting value is used to construct a second hash ring based on the number of online instances on the second hash ring. the second actual location. Similar to step 301-step 302, except that since the representative object is changed from the server to the instance, it is also necessary to realize the continuity of the representative instance based on different setting values.

It should be noted that if the representative server or representative instance goes offline due to an abnormality, the hash ring will determine another server or another instance as a new representative server or representative instance due to the change of the number under the same setting value. Replacement of delegate servers or delegate instances can also be implemented. If the representative server or representative instance that has been disconnected abnormally is capped again, it will be re-determined as a representative server or representative instance based on the same set value, so as to realize the coherence and consistency of the representative server and representative instance, which is conducive to maintaining Configure the latest.

Step 305: Distribute the first control parameter to the normal server instance that is not the server representative instance;

Step 306: delivering the second control parameter to the server representative instance;

The above steps 305 to 306 are the same as the steps 203 to 204 shown in FIG. 2. For the same part, please refer to the corresponding part of the previous embodiment, which will not be repeated here.

Step 307: In response to the node representative instance not setting the default initiating object of the configuration update request, deliver the third control parameter to the node representative instance.

This step is aimed at the situation that the node representative instance does not set the default initiator object of the configuration update request. This situation usually occurs before the initial configuration of the control parameters of each node in the CDN, that is, the current node representative instance has not yet configured the default initiator object, so the third control parameter needs to be delivered to the node representative instance, that is, the third control parameter is used to instruct the node representative instance to only initiate a configuration update request to the console.

Different from the process 200, this embodiment provides an implementation scheme of maintaining the representative server or representative instance based on a fixed set value through steps 301-302 and steps 303-step 304, so as to avoid making the representative server based on the dynamic set value. Or the problem caused by frequent changes of the representative instance; at the same time, considering the fact that the control parameters of the node have not been configured for the first time through step 307, the node representative instance only initiates a configuration update request to the console by issuing the third control parameter, and further, when the node representative instance obtains the latest configuration from the console, other instances will be able to obtain the latest configuration in sequence according to the first control parameter and the second control parameter.

It should be understood that there is no causal or dependent relationship between steps 301-step 302, step 303-step 304, and step 307, and different embodiments can be formed in combination with the process 200. Preferred embodiments of the above three-part preferred implementations exist.

On the basis of any of the above-mentioned embodiments, for the situation that the number of servers included in the node exceeds the preset first number threshold (that is, the number of servers is large), it is also possible to increase the number of representative servers or increase the number of server representative instances in the representative server. To increase the number of node representative instances, and to ensure normal work by setting the working mode of multiple node representative instances to master-slave mode. That is, by adding node representative instances, a single node representative instance can avoid excessive request processing pressure.

Similarly, in the case that the number of instances running on the server exceeds the preset second threshold (that is, the number of instances is large), the number of server representative instances in the server can also be increased, and the work of multiple servers can be represented by the instances. The mode is set to master-slave mode to ensure normal operation. That is, by adding server representative instances, a single server representative instance can be prevented from taking on excessive request processing pressure.

In order to deepen understanding, the present disclosure also provides a specific implementation scheme in combination with a specific application scenario, please refer to FIG. 1:

1) Determine the server B in the first node as the first representative server, and determine the server Y in the second node as the second representative server by consistent hashing based on the server setting value;

2) Determine the instance numbered 1 in each server as the server representative instance through the consistent hashing based on the instance setting value, and determine the remaining instances in the server as the server ordinary instance, and the first representative server and the second representative server are determined. The server representative instance numbered 1 representing the server is respectively determined as the first node representative instance and the second node representative instance;

3) issuing the first control parameter to the common server instance, issuing the second control parameter to the server representative instance, and issuing the third control parameter to the node representative instance;

4) The common instance of the server initiates a configuration update request to the server representative instance according to the effective first control parameter, the server representative instance under the same node initiates a configuration update request to the node representative instance according to the effective second control parameter, and the node representative of each node. The instance initiates a configuration update request to the console of the CDN according to the effective third control parameter.

After the above adjustment, the number of requests to be processed by the console in a unit time will be reduced from hundreds of thousands to hundreds of orders. Therefore, the interval between the configuration requests of the node representative instance can be greatly reduced, and the time for the new configuration to take effect on the CDN can be shortened.

At the same time, the console can deliver the latest configuration file itself and timestamp when delivering the configuration file. When a CDN instance sends a pull configuration request, it will carry the timestamp of its own configuration. The console compares the timestamp carried in the request with the current latest configuration timestamp. If they are the same, the 304 status code is directly returned to indicate that the configuration of the other party is already Latest; if the request timestamp is less than the current latest timestamp, it means that the other party has an old version of the configuration, the console will find the configuration version owned by the request sender according to the old timestamp, and calculate the latest version configuration and the old version through the difference algorithm. The file difference of the version configuration, and the difference description file (generally much smaller than the configuration file itself) is delivered to the requester. After obtaining the difference description file, the requester performs update operation with the local old configuration file, and obtains the latest configuration file for configuration, that is, the amount of data transmission is reduced by incremental update.

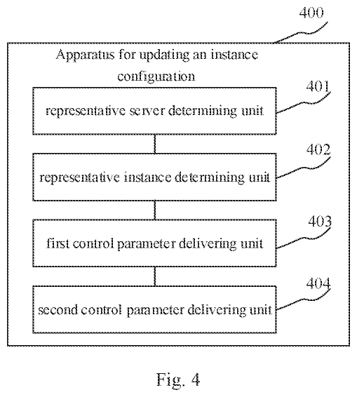

With further reference to FIG. 4, as an implementation of the methods shown in the above figures, the present disclosure provides an embodiment of an apparatus for updating an instance configuration. The apparatus embodiment corresponds to the method embodiment shown in FIG. 2. Can be applied to various electronic devices.

As shown in FIG. 4, the instance configuration updating apparatus 400 in this embodiment may include: a representative server determining unit 401, a representative instance determining unit 402, a first control parameter issuing unit 403, and a second control parameter issuing unit 404. The representative server determination unit 401 is configured to determine the representative server based on the consistent hash for multiple servers included in the node; the representative instance determination unit 402 is configured to determine the representative server based on the consistent hash for multiple instances running on the server. It is desired to determine the server representative instance, and determine the server representative instance of the representative server as the node representative instance; the first control parameter issuing unit 403 is configured to issue the first control parameter to the server common instance that is not the server representative instance; wherein, The first control parameter is used to instruct the server common instance to only initiate a configuration update request to the server representative instance of the same server; the second control parameter issuing unit 404 is configured to issue the second control parameter to the server representative instance; wherein the second control parameter is The control parameter is used to instruct the server representative instance to initiate configuration update requests only to the node representative instance.

In this embodiment, in the instance configuration updating apparatus 400: the representative server determination unit 401, the representative instance determination unit 402, the first control parameter issuing unit 403, and the second control parameter issuing unit 404 The specific processing and the results thereof. For the technical effect, reference may be made to the relevant descriptions of steps 201-204 in the corresponding embodiment of FIG. 2, which will not be repeated here.

In some optional implementations of this embodiment, the instance configuration updating apparatus 400 may further include:

The third control parameter issuing unit is configured to issue a third control parameter to the node representative instance in response to the node representative instance not setting the default initiating object of the configuration update request; wherein the third control parameter is used to instruct the node representative instance to only Make a configuration update request to the console.

In some optional implementations of this embodiment, the representative server determination unit 401 may be further configured to:

For a plurality of servers included in the node, determine the first actual position of the preset server setting value on the first hash ring constructed based on the number of online servers;

The server corresponding to the first actual location is determined as the representative server.

In some optional implementations of this embodiment, the representative instance determination unit 402 may include a server representative instance determination subunit configured to determine a server representative instance based on a consistent hash for a plurality of instances running on a server, a server representative instance, and a server representative instance determination subunit. The representative instance determination subunit can be further configured as:

For multiple instances running on the server, determine the second actual position of the preset instance setting value on the second hash ring constructed based on the number of online instances;

The instance corresponding to the second instance position is determined as the server representative instance.

In some optional implementations of this embodiment, the instance configuration updating apparatus 400 may further include:

The node representative instance increasing unit is configured to increase the number of representative instances of the node by increasing the number of representative servers or increasing the number of server representative instances in the representative server in response to the number of servers included in the node exceeding a preset first number threshold. quantity;

The node representative instance working mode setting unit is configured to set the working mode of a plurality of node representative instances to a master-slave mode.

In some optional implementations of this embodiment, the instance configuration updating apparatus 400 may further include:

The server representative instance increasing unit is configured to increase the number of server representative instances in the server in response to the number of instances running on the server exceeding a preset second number threshold;

The server representative instance working mode setting unit is configured to set the working mode of a plurality of server representative instances to a master-slave mode.

This embodiment exists as an apparatus embodiment corresponding to the above method embodiment. The instance configuration updating apparatus provided by this embodiment can select a representative server from the multiple servers included in each CDN node by means of consistent hashing. Select server representative instances and node representative instances from multiple instances hosted by the same server, and by issuing different control parameters to different instances, adjust the objects that different instances initiate configuration requests, that is, ordinary instances in the server Only the server representative instance initiates a configuration update request to the server representative instance, and the server representative instance only initiates a configuration update request to the node representative instance. Therefore, only the remaining node representative instance will initiate a configuration update request to the console, that is, by initiating object transfer, greatly reducing the number of The console handles the number of requests, and a smaller number of requests will also shorten the waiting time for processing and the time it takes for the new configuration to take effect.

According to an embodiment of the present disclosure, the present disclosure also provides an electronic device, the electronic device includes: at least one processor; and a memory communicatively connected to the at least one processor; wherein, the memory stores data executable by the at least one processor. The instruction is executed by at least one processor, so that when executed by the at least one processor, the example configuration update method described in any of the foregoing embodiments can be implemented.

According to an embodiment of the present disclosure, the present disclosure also provides a readable storage medium, where the readable storage medium stores computer instructions, and the computer instructions are used to enable a computer to implement the instance configuration update described in any of the foregoing embodiments when executed. method.

According to an embodiment of the present disclosure, the present disclosure also provides a computer program product, which, when executed by a processor, can implement the instance configuration update method described in any of the above-mentioned embodiments.

5 shows a schematic block diagram of an example electronic device 500 that may be used to implement embodiments of the present disclosure. Electronic devices are intended to represent various forms of digital computers, such as laptops, desktops, workstations, personal digital assistants, servers, blade servers, mainframe computers, and other suitable computers. Electronic devices may also represent various forms of mobile devices, such as personal digital processors, cellular phones, smart phones, wearable devices, and other similar computing devices. The components shown herein, their connections and relationships, and their functions are by way of example only, and are not intended to limit implementations of the disclosure described and/or claimed herein.

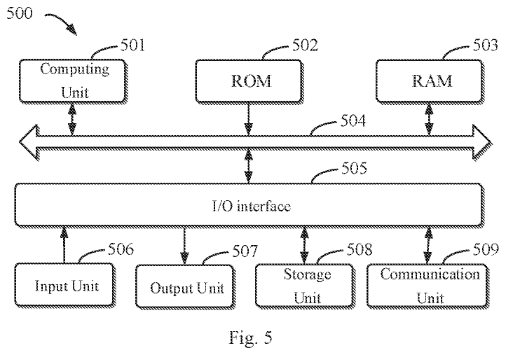

As shown in FIG. 5, the device 500 includes a computing unit 501 that can be executed according to a computer program stored in a read only memory (ROM) 502 or loaded from a storage unit 508 into a random access memory (RAM) 503 Various appropriate actions and handling. In the RAM 503, various programs and data necessary for the operation of the device 500 can also be stored. The computing unit 501, the ROM 502, and the RAM 503 are connected to each other through a bus 504. An input/output (I/O) interface 505 is also connected to bus 504.

Various components in the device 500 are connected to the I/O interface 505, including: an input unit 506, such as a keyboard, mouse, etc.; an output unit 507, such as various types of displays, speakers, etc.; a storage unit 508, such as a magnetic disk, an optical disk, etc.; and a communication unit 509, such as a network card, a modem, a wireless communication transceiver, and the like. The communication unit 509 allows the device 500 to exchange information/data with other devices through a computer network such as the Internet and/or various telecommunication networks.

Computing unit 501 may be various general-purpose and/or special-purpose processing components with processing and computing capabilities. Some examples of computing units 501 include, but are not limited to, central processing units (CPUs), graphics processing units (GPUs), various specialized artificial intelligence (AI) computing chips, various computing units that run machine learning model algorithms, digital signal processing processor (DSP), and any suitable processor, controller, microcontroller, etc. The computing unit 501 performs the various methods and processes described above, such as the instance configuration update method. For example, in some embodiments, the instance configuration update method may be implemented as a computer software program tangibly embodied on a machine-readable medium, such as storage unit 508. In some embodiments, part or all of the computer program may be loaded and/or installed on device 500 via ROM 502 and/or communication unit 509. When the computer program is loaded into RAM 503 and executed by computing unit 501, one or more steps of the example configuration update method described above may be performed. Alternatively, in other embodiments, the computing unit 501 may be configured to perform the instance configuration update method by any other suitable means (eg, by means of firmware).

Various implementations of the systems and techniques described herein above may be implemented in digital electronic circuitry, integrated circuit systems, field programmable gate arrays (FPGAs), application specific integrated circuits (ASICs), application specific standard products (ASSPs), systems on chips system (SOC), load programmable logic device (CPLD), computer hardware, firmware, software, and/or combinations thereof. These various embodiments may include being implemented in one or more computer programs executable and/or interpretable on a programmable system including at least one programmable processor that The processor, which may be a special purpose or general-purpose programmable processor, may receive data and instructions from a storage system, at least one input device, and at least one output device, and transmit data and instructions to the storage system, the at least one input device, and the at least one output device an output device.

Program code for implementing the methods of the present disclosure may be written in any combination of one or more programming languages. These program codes may be provided to a processor or controller of a general purpose computer, special purpose computer or other programmable data processing apparatus, such that the program code, when executed by the processor or controller, performs the functions/functions specified in the flowcharts and/or block diagrams. Action is implemented. The program code may execute entirely on the machine, partly on the machine, partly on the machine and partly on a remote machine as a stand-alone software package or entirely on the remote machine or server.

In the context of the present disclosure, a machine-readable medium may be a tangible medium that may contain or store a program for use by or in connection with the instruction execution system, apparatus or device. The machine-readable medium may be a machine-readable signal medium or a machine-readable storage medium. Machine-readable media may include, but are not limited to, electronic, magnetic, optical, electromagnetic, infrared, or semiconductor systems, devices, or devices, or any suitable combination of the foregoing. More specific examples of machine-readable storage media would include one or more wire-based electrical connections, portable computer disks, hard disks, random access memory (RAM), read only memory (ROM), erasable programmable read only memory (EPROM or flash memory), fiber optics, compact disk read only memory (CD-ROM), optical storage, magnetic storage, or any suitable combination of the foregoing.

To provide interaction with a user, the systems and techniques described herein may be implemented on a computer having a display device (eg, a CRT (cathode ray tube) or LCD (liquid crystal display) monitor) for displaying information to the user); and a keyboard and pointing device (eg, a mouse or trackball) through which a user can provide input to the computer. Other kinds of devices can also be used to provide interaction with the user; for example, the feedback provided to the user can be any form of sensory feedback (eg, visual feedback, auditory feedback, or tactile feedback); and can be in any form (including acoustic input, voice input, or tactile input) to receive input from the user.

The systems and techniques described herein may be implemented on a computing system that includes back-end components (eg, as a data server), or a computing system that includes middleware components (eg, an application server), or a computing system that includes front-end components (eg, a user's computer having a graphical user interface or web browser through which a user may interact with implementations of the systems and techniques described herein), or including such backend components, middleware components, Or any combination of front-end components in a computing system. The components of the system may be interconnected by any form or medium of digital data communication (eg, a communication network). Examples of communication networks include: Local Area Networks (LANs), Wide Area Networks (WANs), and the Internet.

A computer system can include clients and servers. Clients and servers are generally remote from each other and usually interact through a communication network. The relationship of client and server arises by computer programs running on the respective computers and having a client-server relationship to each other. The server can be a cloud server, also known as a cloud computing server or a cloud host. It is a host product in the cloud computing service system to solve the management difficulties in traditional physical host and virtual private server (VPS, Virtual Private Server) services. Large, weak business expansion defects.

According to the technical solutions of the embodiments of the present disclosure, through a method based on consistent hashing, a representative server can be selected from multiple servers included in each CDN node, a representative server instance can be selected from multiple instances carried by the same server, and Nodes represent instances, and by sending different control parameters to different instances, the objects that different instances initiate configuration requests are adjusted, that is, ordinary instances in the server only initiate configuration update requests to server representative instances, and server representative instances only send configuration update requests to nodes. The representative instance initiates a configuration update request, so only the remaining node representative instance will initiate a configuration update request to the console, that is, by initiating the transfer of objects, the number of requests processed by the console is greatly reduced, and the number of requests processed by the lesser number will also be reduced. Shorten the processing time and the time required for the new configuration to take effect.

It should be understood that steps may be reordered, added or deleted using the various forms of flow shown above. For example, the steps described in the present disclosure can be executed in parallel, sequentially, or in different orders. As long as the desired results of the technical solutions disclosed in the present disclosure can be achieved, no limitation is imposed herein.

The above-mentioned specific embodiments do not constitute a limitation on the protection scope of the present disclosure. It should be understood by those skilled in the art that various modifications, combinations, sub-combinations and substitutions may occur depending on design requirements and other factors. Any modifications, equivalent replacements and improvements made within the spirit and principles of the present disclosure should be included within the protection scope of the present disclosure.

1. An instance configuration update method, comprising:
For multiple servers included in the node, the representative server is determined based on the consistent hash;
For a plurality of instances running on the server, determine a server representative instance based on the consistent hash, and determine the server representative instance of the representative server as a node representative instance;
delivering a first control parameter to a common server instance that is not the representative instance of the server; wherein, the first control parameter is used to instruct the common server instance to only initiate a configuration update request to the representative server instance of the same server;
Delivering a second control parameter to the server representative instance; wherein the second control parameter is used to instruct the server representative instance to only initiate a configuration update request to the node representative instance.

2. The method of claim 1, further comprising:
In response to the node representative instance not setting the default originating object of the configuration update request, a third control parameter is issued to the node representative instance; wherein, the third control parameter is used to instruct the node representative instance to only report to the console Initiate a configuration update request.

3. The method according to claim 1, wherein, for the plurality of servers included in the node, the representative server is determined based on the consistent hash, comprising:
For a plurality of servers included in the node, determine the first actual position of the preset server setting value on the first hash ring constructed based on the number of online servers;
The server corresponding to the first actual location is determined as the representative server.

4. The method of claim 1, wherein, for a plurality of instances running on the server, determining a server representative instance based on consistent hashing comprises:
For multiple instances running on the server, determine the second actual position of the preset instance setting value on the second hash ring constructed based on the number of online instances;
The instance corresponding to the second instance location is determined as the server representative instance.

5. The method of any one of claims 1-4, further comprising:
In response to the number of servers included in the node exceeding a preset first number threshold, increasing the number of representative instances of the node by increasing the number of the representative servers or increasing the number of server representative instances in the representative server;
The working mode of a plurality of said node representative instances is set to master-slave mode.

6. The method of any one of claims 1-4, further comprising:
In response to the number of instances running on the server exceeding a preset second number threshold, increasing the number of server representative instances in the server;
Set a plurality of said server representative instances to work in master-slave mode.

7. An instance configuration update device, comprising:
a representative server determination unit, configured to determine a representative server based on the consistent hash for a plurality of servers included in the node;
a representative instance determination unit, configured to determine a server representative instance based on a consistent hash for a plurality of instances running on the server, and determine the server representative instance of the representative server as a node representative instance;
The first control parameter issuing unit is configured to issue the first control parameter to the common server instance that is not the representative instance of the server; wherein, the first control parameter is used to instruct the common server instance to only send the common server to the same server. The server initiates a configuration update request on behalf of the instance;
A second control parameter issuing unit, configured to issue a second control parameter to the server representative instance; wherein the second control parameter is used to instruct the server representative instance to only initiate a configuration update to the node representative instance ask.

8. The apparatus of claim 7, further comprising:
The third control parameter issuing unit is configured to issue a third control parameter to the node representative instance in response to that the node representative instance does not set the default initiating object of the configuration update request; wherein, the third control parameter uses Instructing the node to only initiate a configuration update request to the console on behalf of the instance.

9. The apparatus of claim 7, wherein the representative server determination unit is further configured to:
For a plurality of servers included in the node, determine the first actual position of the preset server setting value on the first hash ring constructed based on the number of online servers;
The server corresponding to the first actual location is determined as the representative server.

10. The apparatus of claim 1, wherein the representative instance determination unit comprises a server representative instance determination subunit configured to determine a server representative instance based on a consistent hash for a plurality of instances running on the server, the server representative instance determination subunit is further configured to:
For multiple instances running on the server, determine the second actual position of the preset instance setting value on the second hash ring constructed based on the number of online instances;
The instance corresponding to the second instance location is determined as the server representative instance.

11. The apparatus of any one of claims 7-10, further comprising:
The node representative instance increasing unit is configured to increase the number of representative servers by increasing the number of representative servers or increasing the number of server representative instances in the representative server in response to the number of servers included in the node exceeding a preset first number threshold. the node represents the number of instances;
The node representative instance working mode setting unit is configured to set the working mode of a plurality of the node representative instances to a master-slave mode.

12. The apparatus of any one of claims 7-10, further comprising:
A server representative instance increasing unit, configured to increase the number of server representative instances in the server in response to the number of instances running on the server exceeding a preset second number threshold;
The server representative instance working mode setting unit is configured to set the working mode of a plurality of the server representative instances to a master-slave mode.

13. A request processing system, comprising:
The representative selection and control parameter issuing device is used to determine the representative server based on the consistent hash for multiple servers included in the node; for the multiple instances running on the server, the server representative instance is determined based on the consistent hash, and Determining the server representative instance of the representative server as the node representative instance; delivering the first control parameter to the normal server instance that is not the server representative instance; delivering the second control parameter to the server representative instance;
The common instance of the server is used to only initiate a configuration update request to the server representative instance of the same server according to the received first control parameter;
The server representative instance is configured to only initiate a configuration update request to the node representative instance according to the received second control parameter.

14. An electronic device comprising:
at least one processor; and
a memory communicatively coupled to the at least one processor; wherein,
The memory stores instructions executable by the at least one processor, the instructions being executed by the at least one processor to enable the at least one processor to perform the execution of any of claims 1-6 The instance configuration update method of.

15. A non-transitory computer-readable storage medium storing computer instructions for causing the computer to perform the instance configuration update method of any one of claims 1-6.

16. A computer program product comprising a computer program which, when executed by a processor, implements the steps of the example configuration update method according to any one of claims 1-6.
